(19) United States
(12) Patent Application Publication
(10) Pub. No.: US 2012/0210895 A1
(43) Pub. Date: Aug. 23, 2012

(54) METHOD FOR PERFORMING PRINT JOB

(76) Inventor: Manfred Loddenkoetter, Ibbenbueren (DE)

(21) Appl. No.: 13/505,328

(22) PCT Filed: Nov. 10, 2010
(86) PCT No.: PCT/EP2010/067239

§ 371 Date: May 1, 2012

(30) Foreign Application Priority Data
Nov. 10, 2009 (DE) 102009046566.9

(51) Int. Cl. B41F 1/34

(52) U.S. Cl. 101/481; 101/485

(57) ABSTRACT

The invention describes a method for performing print jobs,
whereby use is made of a flexographic printing press comprising a plurality of inking units to print print carriers,
whereby at least two of these inking units each have a printing plate cylinder that has a printing form and a printing form carrier to produce printed images,
and whereby the register between the printing plate cylinders located in the inking units is adjusted on the basis of measurement signals,
related to the position of bodies or markings, which are carried by the printing form or the printing plate carrier.

The body or the marking is applied to the surface of the printing form or the printing plate carrier, and the body or the marking in turn is at least a register mark or has a register mark.

The invention relates to a method for performing print jobs, a flexographic printing press as well as a body. For the exact configuration of the objects of the invention, refer to claims 1, 5 and 9.

For the processing of print jobs using multi-color presses, it is necessary to align the register positions of the plate cylinders with one another.

In flexographic printing presses—especially in the case of central cylinder flexographic printing presses—the register setting is usually carried out with the help of a so-called rail-track process. In order to carry out these methods, the printing forms, with which the individual printing plate cylinders are equipped, have register marks; which provide the print substrate with register marks. In the case of simultaneous multiple color printing, the position of the register marks on the print substrate in the individual printing units can be measured. By correcting the angular position of the printing plate cylinders with respect to one another during the longitudinal register adjustment, a target distance is set between the register marks. When setting the lateral register, the axial position of the printing plate cylinders with respect to one another can be corrected until the print substrate again reaches the target distance between the register marks of the various printing units.

Document EP 1 916 102 A1 differs from the above standard approaches to registering flexographic printing presses:

In an external cylinder holder, often called the horizontal bar, various measurements are carried out on a printing plate cylinder carrying a flexographic printing plate. One of these measurements determines the position of a magnetic pin that is applied to the printing form or the printing form carrier.

Afterwards, several printing plate cylinders that are handled in this way are assembled into an inking unit of the printing press. In the printing press, the angular position of the magnetic pin on the printing plate cylinder is measured, and the register positions of the cylinders adjusted with respect to one another.

Therefore, in EP 1 916 102A1, the register between the printing plate cylinders in the inking units is adjusted on the basis of measurement signals which relate to the position of bodies, which are carried on the printing form or printing form carrier.

The bodies are the magnetic pins located on the printing forms. The disadvantages of such a procedure is that the measurement of the position of the magnetic pin in a printing form is complicated and magnetic measurement techniques are unusual in printing technology. In addition, the measurement of the printing plate cylinder in an external horizontal bar involves an additional operation that takes time and is complicated.

The object of the present invention is to eliminate these disadvantages.

The object is achieved by the addition of the characterizing features to a process in accordance with EP 1 916 102 A1.

According to the invention, this object is achieved by the features of the characterizing part of claim 1.

Accordingly, a body or a marking is applied to the printing form or printing form carrier. In the case of marking, a marking such as a register mark is used. In the case of the body, a mark is applied to the body with respect to the register mark. “Applied” in the sense of the present document, means that something is applied to the surface of the printing form carrier and connected with it. In this case, a solid connection means one using an adhesive bond.

The body or the marking should be applied to the printing form carrier or the printing form at a certain known relative position (at least known to a control device). Then, by determination of the relative position of the marking or the body in the printing unit in which the relevant printing plate cylinder is assembled, the position of the printing form can be determined.

It is advantageous to apply the additional body or the marking to the printing form or printing plate cylinder during setup of the printing plate cylinder. This setup procedure is often performed by a so-called mounter. Such a mounter is shown, inter alia, in document US 20060117973 A1. Mandrels, rollers or adapter sleeves are often clamped in these devices. Then printing plates are often clamped or glued on this body. It is also known to provide further sleeves carrying the printing form between the first-mentioned printing form carrier and the printing plates.

The mounters are equipped with optical and mechanical devices that enable accurate positioning of the plates on the surface of the printing plate carrier.

As a rule, a reference point (often called microdot) is provided on the printing plates which in turn enables the printing plate to be positioned exactly on the printing form.

In order to carry out the inventive method, in addition to the accurate positioning of the printing plate on the printing form carrier, a precise positioning of the additional body on the printing form carrier or the printing plate can be carried out.

In this context, the additional body can be applied, inter alia, to the surface of the printing plate cylinder, the printing plate or firmly fixed to the objects mounted on the printing plate cylinder. It is regarded as advantageous if the body or the markings applied to the body can be seen, or if they can be identified with optical sensors. The term “optical sensors” used here also includes sensors that can detect electromagnetic radiation outside the visible range. Nevertheless, it is advantageous to use sensors that are sensitive to the range of visible light.

If commercially-available mounters can be slightly retooled, other methods are advantageous: thus engraving tools can be used to engrave the marks on the relevant surface (rear of the printing plate cylinder, the printing plate or other objects fixed to the printing plate cylinder). It also appears advantageous to use devices that can print on the relevant surfaces. Thus, in this case, ink jet heads—as used in inkjet printers—can also be used.

Especially in the case of engraving and printing processes, the application of the markings can be automated, which also offers gains in accuracy in positioning when applying the marking.

Conventional central cylinder flexographic printing presses are not suitable for implementing the inventive method. These presses generally have register mark sensors for all downstream inking units. They are arranged in such a working position that several, or preferably all, of the printing substrates on the inking units can be seen. They permit viewing of a register mark field in which is contained a mark of each inking unit. A printing press that implements the inventive method must measure the relative position (relative angular position) of the printing plate cylinder (or, better, of the printing plates) of at least two inking units. Therefore, it requires at least two register mark sensors that can be applied to the printing plate cylinders in a working position. The positioning of the register mark sensors is not critical as the requirements for the resolution that must be achieved with the sensors is high.

In general, the working position of the sensors will be in the areas of the inking units where this can lead to contamination of the sensor through ink mist and splashes and the like. Therefore, it is advantageous if the sensors can be moved away from these areas of the inking unit. The sensors can, when they are in the working position, for example, take measurements for a pre-registering. They can also take register readings during the printing process. The latter is rather the exception, especially in the case of central cylinder printing presses.

Advantageously, the transport device should be able to pivot the register mark sensors around an axis of rotation away from the exposed areas of the inking unit. It has been found that it is advantageous to tilt the axis of rotation relative to the base frame of the associated inking unit (angle of deviation of 90°).

The registration mark sensors 15 or sensor heads 14, which may be contaminated in their operating position by ink splashes and the like, can be cleaned, inter alia, in the pivoted position. In a pivoted position, a protective housing may be used for the sensor 15 or at least the sensor head 14. This protective housing protects the sensor 15 or at least the sensor head 14 against further contamination. In such a protective housing, the sensor can also be checked: thus there can be a wall in the protective housing that is the same color as a part of the additional body. Then the sensor can check whether it receives remitted light from this wall with the original intensity, when it emits light towards the wall at a certain (original) intensity.

If this is not the case, the radiation output or radiation input of the sensor 15, or at least the sensor head 14, is contaminated (frequently both).

Due to the changes in the readings, a control and computing unit recalibrates the sensor. An addition or alternative to this approach lies in automatic cleaning, for example, when a deviation of the readings that exceeds a given output value is determined by the corresponding control and computing unit. The control and computing unit may also issue a warning signal to the machine operator that causes him to clean the sensor 15, or at least the sensor head 14.

With respect to the additional body, the following has been found to be advantageous:

It is advantageous if it can be applied to the surface of the printing form or printing form carrier. To this end, the body can have a flat form and, for example, be applied as a label to the surface. Bodies having a flat form have two major surfaces, i.e. a front and a rear side. The rear side of the additional body should be connectable to the printing form. The front side should carry at least one register mark.

The body can, for example, be a strip of material whose longitudinal axis is preferably oriented in the circumferential direction of the roller. An even number of markings or marks are advantageously applied to the body. A symmetrical design of the marking field relative to a reference point is an advantage and allows, for example, differential readings. Furthermore, one can determine the mean value between the position values of two points arranged symmetrically to a reference point in order to minimize the effect of reading errors that could result from an inaccurate assembly of the body to the printing form.

It is advantageous to use both rectangular marks or markings as well as triangular, trapezoidal or frustoconical shapes.

Further embodiments of the invention follow from the objective description and the claims. The individual figures show:

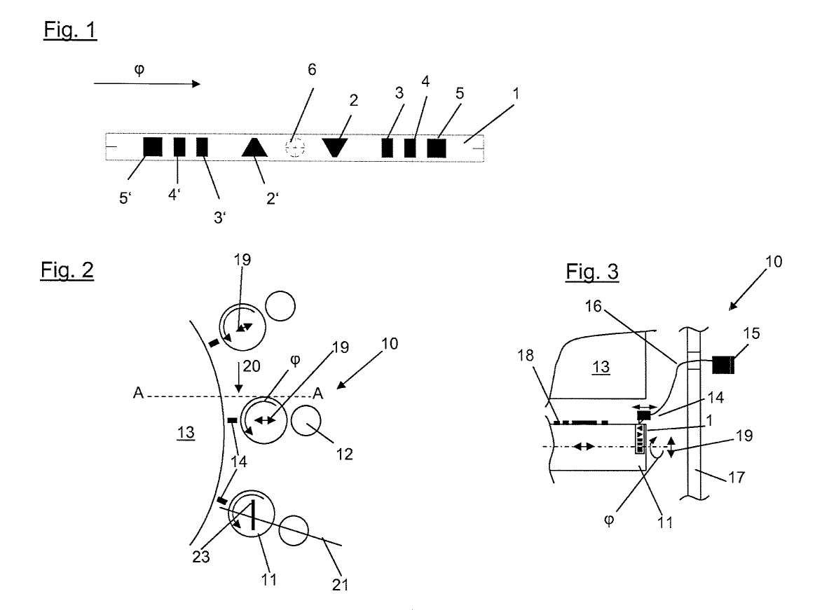

FIG. 1 Plan view of a strip-shaped additional body

FIG. 2 Schematic side view of a three color inking unit of a central cylinder flexographic printing press

FIG. 3 Schematic view of the printing unit 10 of FIG. 2

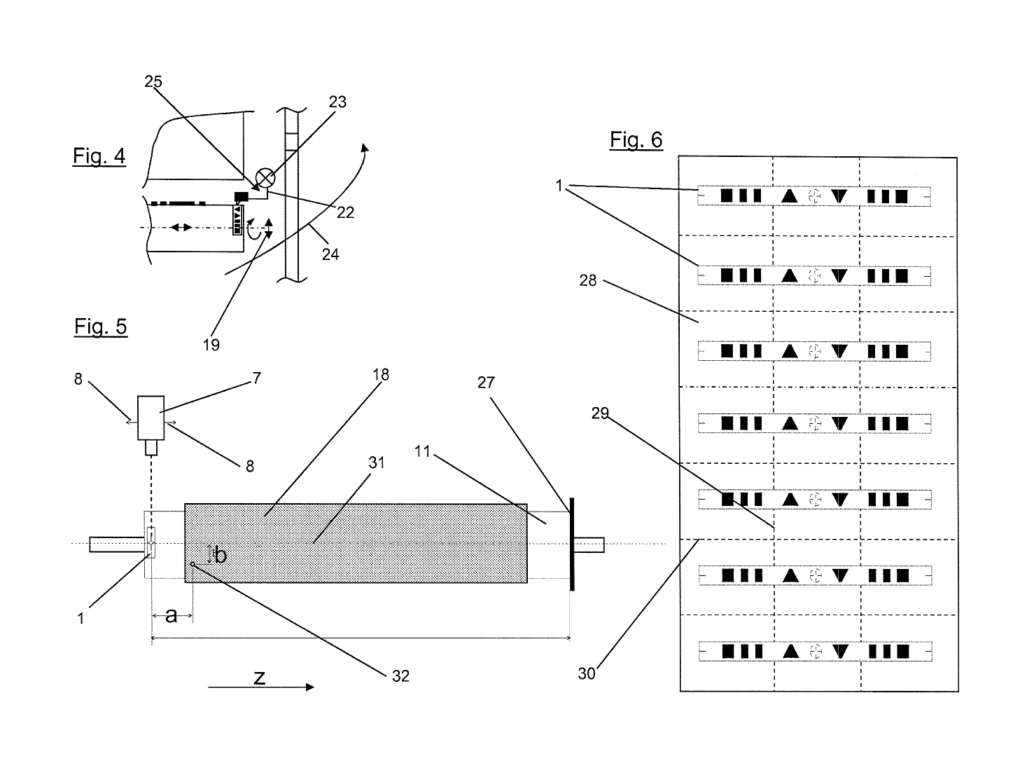

FIG. 4 Schematic view of the printing unit 10 of FIG. 2 with additional features

FIG. 5 Plate cylinder 11 equipped with a printing plate and an additional body

FIG. 6 Additional body 1 applied to a carrier material 28 for handling and storage reasons.

FIG. 1 shows a strip-shaped stamped additional body 1. This carries a plurality of marks 2, 2′, 3, 3′, 4, 4′, 5, 5′ that are arranged and formed symmetrically with respect to the reference point 6. The strip-shaped body 1 is intended to be aligned with its longitudinal direction in the circumferential direction φ of a format cylinder 11. The arrangement and orientation of the strip allows a differential reading between the pairs of points n, n′ arranged symmetrically with respect to the reference point 6. As a result of this differential reading, it is possible to minimize errors that might occur due to inaccuracies in the alignment of the body on the printing form carrier or the printing form. The edges of the marks 2 and 2′ that are oblique to the circumferential direction f of the form cylinder 11 serve for the lateral register control. The other marks are used, inter alia, for the longitudinal register control. It is advantageous for the marks 2 and 2′ to be black and the substrate white. It is also advantageous to have marks with a rectangular and/or triangular shape.

FIG. 2 shows a schematic side view of three inking units 10 of a central cylinder flexographic printing press 26. The typical components of such a machine include the central impression cylinder 13 as well as the plate cylinder 11 and the anilox rollers 12 of the individual inking units 10. The plate cylinder 11 and the anilox roller 12 face away from one another. The arrows 19 symbolize the approach direction of the cylinder. Furthermore, the sensor heads 14 can be seen in the working position in FIG. 2.

In FIG. 3, the area delineated by the line A-A of an inking unit 10 can be seen from the viewing direction indicated by the arrow 20.

In addition to the features already shown in FIG. 2, FIG. 3 shows the machine frame 17, the plate 18 and the fiber optics 16 and sensor 15.

FIG. 4 shows the inking unit 10 from the same direction as FIG. 3. The arm 22 and the rotational axis 23 of the transport device 25 with respect to the sensor or the sensor head 14 can be seen. The arrow 24 indicates the pivoting direction of the sensor head. As mentioned above, the pivoting takes place about an axis 23. This axis is also shown in FIG. 2. In FIG. 2 as well, it can be seen that the angle between the axis 22 and the base frame of the inking unit 21 is not a right angle.

The sensor device consists in total of the sensor head 14, the fiber optics 16 and the sensor 15. Such an arrangement is advantageous when it comes to positioning the sensor head 14 in a chemically critical atmosphere and to placing the sensor 15 with its critical components outside this area. The sensor head can then receive the light remitted from the register marks 2, 2′ with respect to the additional body 1 or another part of the plate cylinder 11 and forward it to the sensor 15 via the fiber optics.

It is often advantageous to also arrange a light source in the housing of the sensor 15 to supply the sensor head 14 via the fiber optics 15 so that it can also illuminate the surroundings of the register marks.

FIG. 5 shows a plate cylinder 11 which is clamped in a mounter (not shown). The plate 18 in this mounter has already been applied in the exact position on the format cylinder 11. An imaginary line 31 often serves to align the plate whereby the line can be moved along the recording area of the camera or viewing aid 7 in their directions of movement 8. The camera can then “move” fixed points on the plate cylinder (its area of recording is adjusted to this point) whereby it is moved in the axial direction z of the plate cylinder and whereby the plate cylinder is rotated in the circumferential direction f. The change in the axial position z of the camera 7 is measurable with a distance sensor. Also, the rotational angle change of the plate cylinder can be measured with a rotation angle sensor on the mounter, so that the distance covered in the circumferential direction f can be determined when the diameter of the plate cylinder is known. In this way, positions at desired intervals from one another on the surface of the format cylinder can be determined with the help of its mounter and camera 7. The operator of the mounter can thus position the plate 18 and the additional body 1 at a given distance from one another (for example, by aligning and bonding). In the case of automated application, for example, of printed marks on the surface of the cylinder 11, even more accurate positioning can be achieved.

So-called micro-dots 32 are often used as fixed points on the plate. Plate cylinders 11 are often provided with a stop 27 on its entry side (depicted in FIG. 5 on the left) against which stop 27 a sleeve or a plate can butt to limit the displacement movement of the sleeve on the plate cylinder.

In FIG. 6, a plurality of additional bodies 1 is applied to a tape material 28 (the additional bodies are seen in the foreground from the perspective of the viewer): the additional bodies 1 are self-adhesive on their rear sides. They can be removed by the machine operator from the tape material 28 and applied to the plate cylinder 11. It is advantageous to perforate the tape-shaped carrier material 28 or to weaken it in some other way so that there are tear lines.

As a result of the horizontal lines of perforations 30, the machine operator can detach individual bodies 1 from the carrier material 28. Using the vertical lines of perforations 29, he may gradually remove successive parts of the self-adhesive surface of the additional body 1.

The tape-shaped material 28 can be rolled up with the additional bodies into rolls. Such a roll has many benefits.

It is advantageous to carry out all the above-described and claimed methods or computer-implemented method steps. Accordingly, a control unit is provided which is so set that it controls machine components for performing the method.

### List of Reference Numerals

1 Additional body
2 2′ Mask
3 3′ Mask
3 4′ Mask
5 5′ Mask
6 Reference point
7 Camera of the mounter
8 Arrows in the direction of movement of the camera of the mounter
9
10 Inking unit
11 Plate cylinder
12 Anilox roller
13 Impression cylinder
14 Sensor head
15 Sensor
16 Fiber optics
17 Machine frame
18 Plate
19 Arrow in setting direction
20 Arrow in viewing direction in FIG. 2
21 Basic frame of the inking unit
22 Arm
23 Pivot point/axis
24 Arrow in the direction of pivoting
25 Transport device
26 Flexographic printing press
28 Tape material to support the bodies 1/labels
29 Vertical perforation line
30 Horizontal perforation line
31 Pitch line (movable focus area of the camera 7)
32 Micro point of plate 18
f Direction/circumferential direction
a Distance in the axial direction of the plate cylinder
b Distance in the circumferential direction of the plate cylinder
z Axial direction

1. A method for performing print jobs,
whereby use is made of a flexographic printing press (26) comprising a plurality of inking units (10) to print print carriers,
whereby at least two of these inking units (10) each have a printing plate cylinder that has a printing form (18) and a printing form carrier to produce printed images,
and whereby the register between the printing plate cylinders (11) located in the inking units is adjusted on the basis of measurement signals,
related to the position of bodies (1) or markings, which are carried by the printing form (18) or the printing plate carrier (11),
whereby the body (1) or the marking is applied to the surface of the printing form (18) or the printing plate carrier (11),
characterized in
that the body (1) or the marking in turn is at least a register mark or has a register mark,
that the means for the detection of register marks are brought by a transport device into a working position in which the positions of register marks on the outer circumference of the printing plate cylinder (11) can be seen,
that the position of the body (1) or markings is detected with these means by the detection of register marks,
and that the means for the detection of register marks with a transport device (25) can be brought into a position of rest away from the inking unit.

2. A method according to claim 1,
characterized in that
the additional body (1) is applied at a certain position relative to the printing form (18) on the printing form (18) or the printing plate carrier (11).

3. A method according to claim 2,
characterized in that
the additional body (1) is applied to the printing form (18) or the printing form carrier (11) during setup of the printing plate cylinder (11).

4. A method according to claim 1,
characterized in that
the additional body (1) carries a plurality of register marks (2, 3, 4, 5).

5. Flexographic printing press,
whereby a plurality of inking units (10) is arranged around a central impression cylinder (13) containing means (14) for detecting the position of register marks (2, 3, 4, 5), and the means (14) for detecting the positions of the register marks (2, 3, 4, 5) are present on at least two inking units (10),
characterized in
that the means (14) for detecting the positions of the register marks (2, 3, 4, 5) can be brought into a working position by a transport device in which the positions of register marks on the outer circumference of the printing plate cylinder (11) are detectable.
and that the means (14) for detecting the positions of the register marks (2, 3, 4, 5) are hinged on a transport device (25), with which they (24) are transported from the working position into a position of rest away from the inking unit.

6. Flexographic printing press according to claim 5,
characterized in that
the transport device (25) is a pivoting device, with which the means (14) for detecting the positions of the register marks are pivotable about a rotation axis (23) on being transported between the working position and the position of rest.

7. Body which is connected to a printing form or a printing form carrier,
characterized in
that the body (2) carries at least one registration mark (2, 3, 4, 5),
that the body (2) has a flat form,
that a large area can be connected with the printing form (18) or the printing form carrier (11),
that the other large area carries at least one registration mark (2, 3, 4, 5),
and that the body (2) carries marks with a triangular or trapezoidal shape.

8. Body according to claim 1,
characterized in
that the body (2) has a register mark area with at least two register marks (2, 3, 4, 5).

9. Body according to claim 1,
characterized in
that the body (2) comprises at least two register marks (2, 3, 4, 5) that are arranged and shaped symmetrically with respect to a reference point (6).

10. Body according to claim 1,
characterized in
that the body (2) has marks (3, 4, 5) having a rectangular shape.

11. Body according to claim 1,
characterized in
that the body (2) carries at least four marks.

12. Body according to claim 1,
characterized in
that the body (2) has at least a self-adhesive surface.

13. Body according to claim 1,
characterized in
that the body (2) is releasably fixed to a tape-shaped material (28) for storage purposes.

14. (canceled)

15. (canceled)

16. (canceled)

17. (canceled)
